(19) United States
(12) Patent Application Publication
(10) Pub. No.: US 2008/0122589 A1
(43) Pub. Date: May 29, 2008

(54) Tactile Output Device

(76) Inventor: Yuri A. Ivanov, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/563,760

(22) Filed: Nov. 28, 2006

(51) Int. Cl. G08B 6/00; G09B 21/00

(52) U.S. Cl. 340/407.1; 434/114

(57) ABSTRACT

A tactile output device including an electro-active polymer layer and first and second sets of coplanar conductors arranged proximate to the layer. The first and second sets of conductors are approximately at right angles to each other, and the conductors in each set are spaced apart and parallel to each other. The conductors can be selected individually to convey current to expand and contract the electro-active polymer in vicinities where the conductors intersect. The selection can be according to pixels in an image to product a three-dimensional contoured surface corresponding to the image.

### FIELD OF THE INVENTION

This invention relates generally to output devices, and more particularly to tactile output devices.

### BACKGROUND OF THE INVENTION

Most graphic output to users is via a display unit. The display can be two-dimensional, and less frequently, three-dimensional. The assumption is that most users can view the display.

However, there are a number of situations where this assumption is wrong. In some situations, the user's visual system is otherwise occupied on more important tasks, such as navigation or tending to dangerous equipment. Other situations might preclude the installation of a display unit in the user's line of sight. Some users may be physically impaired to the extent that it is difficult or impossible for them to use a display unit.

Therefore, tactile output devices have been developed. The most common type of tactile output device is a Braille reader, see U.S. Pat. No. 6,255,938, “Device for the input and read-out of data,” issued to Bornschein on Jul. 3, 2001. That type of device uses mechanical pins and is limited in that it can only convert text to tactile output.

Another type of device converts images to tactile output, see U.S. Pat. No. 6,703,924 “Tactile display apparatus,” issued to Tecu et al. on Mar. 9 2004. That device includes an array of electro-mechanical output elements, with each element corresponding to at least one pixel in an image. The elements are in the form of movable pins coupled to linear stepping motors.

Most prior art tactile output device use pins and are activated using electro-mechanical components. There are a number of problems with such devices. They are relatively complex, expensive to manufacture, heavy, require considerable power, and subject to latency. Portability is a serious concern.

Therefore, it is desired to provide a tactile output device that overcomes the limitations of the prior art.

### SUMMARY OF THE INVENTION

The embodiments of the invention provide a tactile output device capable of rendering images as three dimensional contours. Such a device can be used in conjunction with front- or rear-projected visual display elements to achieve tactile interaction with computers, displays, appliances and other devices. The device allows for relief rendering by means of an electro-active polymer film that is locally activated to generate a sensation of a raised tactile pixel. Such elementary tactile elements can be further combined into continuous surface relief that can be sensed by touch.

The tactile output device includes an electro-active polymer layer, and first and second sets of coplanar conductors arranged proximate to the layer. The first and second sets of conductors are approximately at right angles to each other, and the conductors within each set are spaced apart and parallel to each other. The conductors can be selected individually to convey current to expand and contract the electro-active polymer in vicinities where the conductors intersect. The selection can be according to pixels in an image to produce a three-dimensional contoured surface corresponding to the image.

### BRIEF DESCRIPTION OF THE DRAWINGS

FIG. 1 is an isomeric view of a tactile output device according to an embodiment of the invention;

FIG. 2 is a top view of the device of FIG. 1;

FIG. 3 is a block diagram of a system incorporating the device of FIG. 1;

FIG. 4 is a side view of the device of FIG. 1 with two layers; and

FIG. 5 is a view of the device of FIG. 1 with embedded conductors.

### DETAILED DESCRIPTION OF THE PREFERRED EMBODIMENT

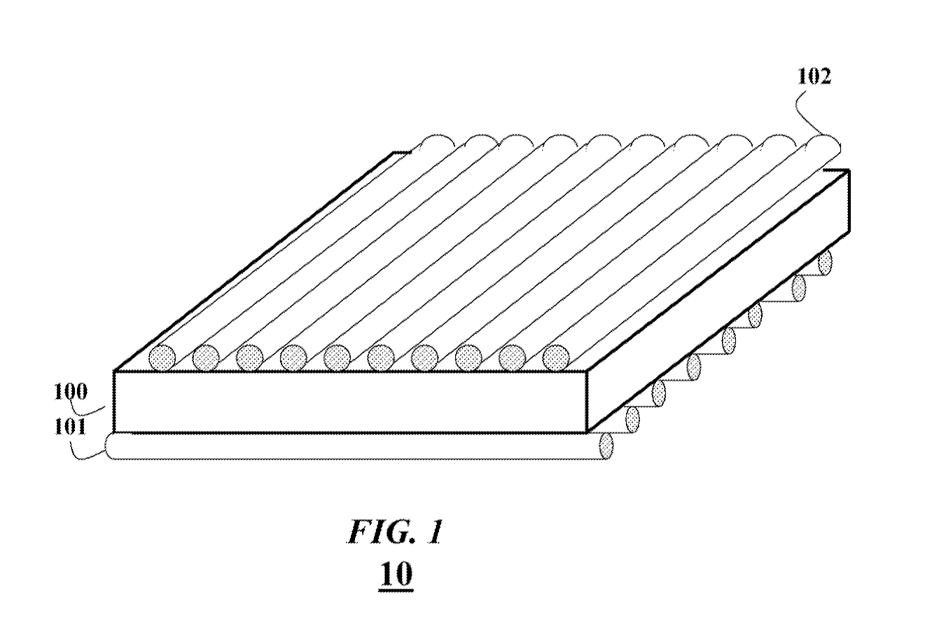

FIGS. 1, 2, 4 and 5 show a tactile output device 10 according to an embodiment of the invention, not to scale. The device includes an electro-active polymer layer 100, see below.

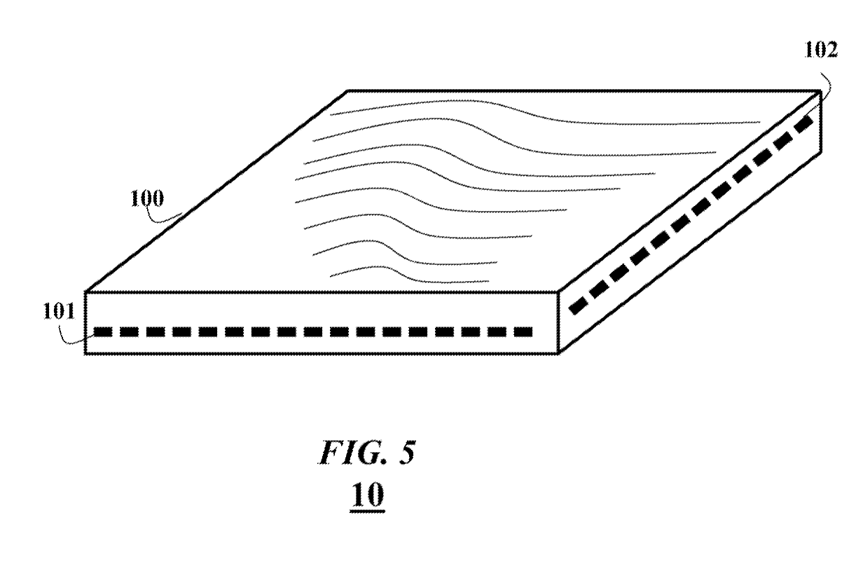

One set of conductors 101 are arranged on one side to the layer, and another set of conductors 102 are arranged on another side of the layer. The conductors in each set are spaced apart and parallel to each other. The sets 101 and 102 are at right angles to each other. The conductors in each set are coplanar with the layer. It should also be understood that the conductors can be embedded in the layer, see FIG. 5. The conductors can be cylindrical or rectangular in cross section. In a preferred embodiment, the conductors are deformable.

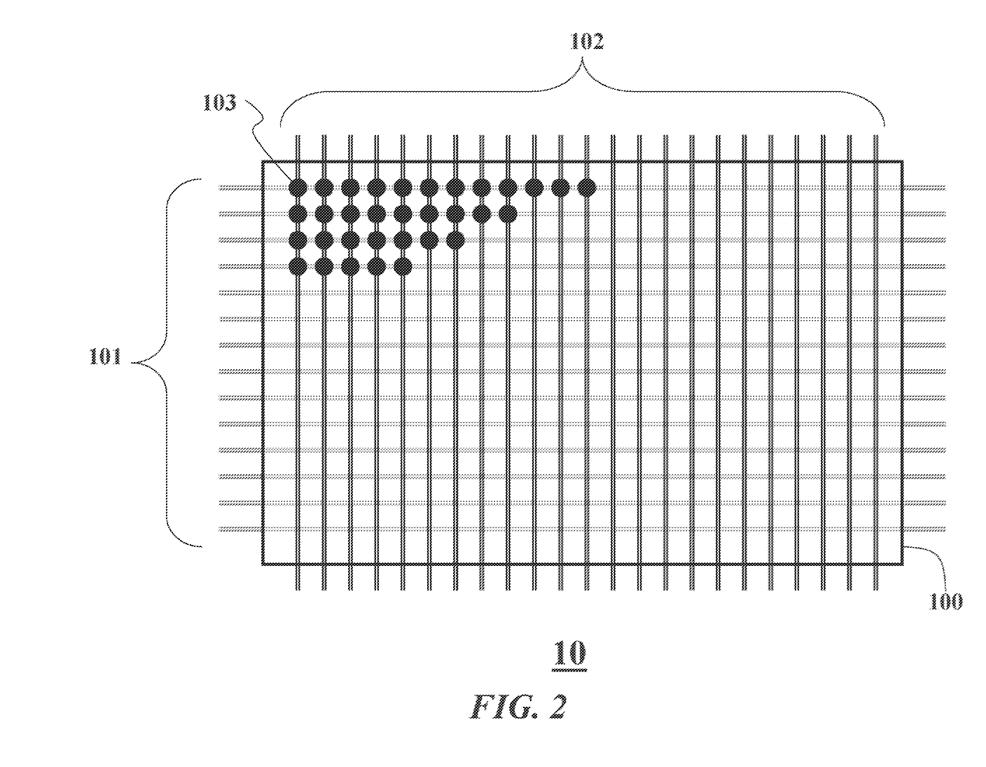

As shown in FIG. 2 when viewed vertically, the conductors 101-102 intersect each other at and array of points 103. Because of the above arrangement of the conductors, the points form an array, e.g., the array can be regular or irregular. The conductors are individually addressable, similar to the way pixels are addressed on a visual display. The points 103 correspond to a pixel array in an output relief image.

Depending on current applied to a selected pair of conductors, the polymer layer at the point of intersection of the conductors can expand of contract. The amount of expansion or contraction can be controlled by the amount of current. The polymer can expand by as much as a factor of three in terms of volume. The force exerted can be up to 100 N/cm².

Thus, during operation, the layer 100 has a tactile texture. Tactile texture is the actual (3D) feel of a surface. Tactile texture can be rough, smooth, thick, thin, sandy, soft, hard, warty, coarse, fine, regular or irregular, and moving.

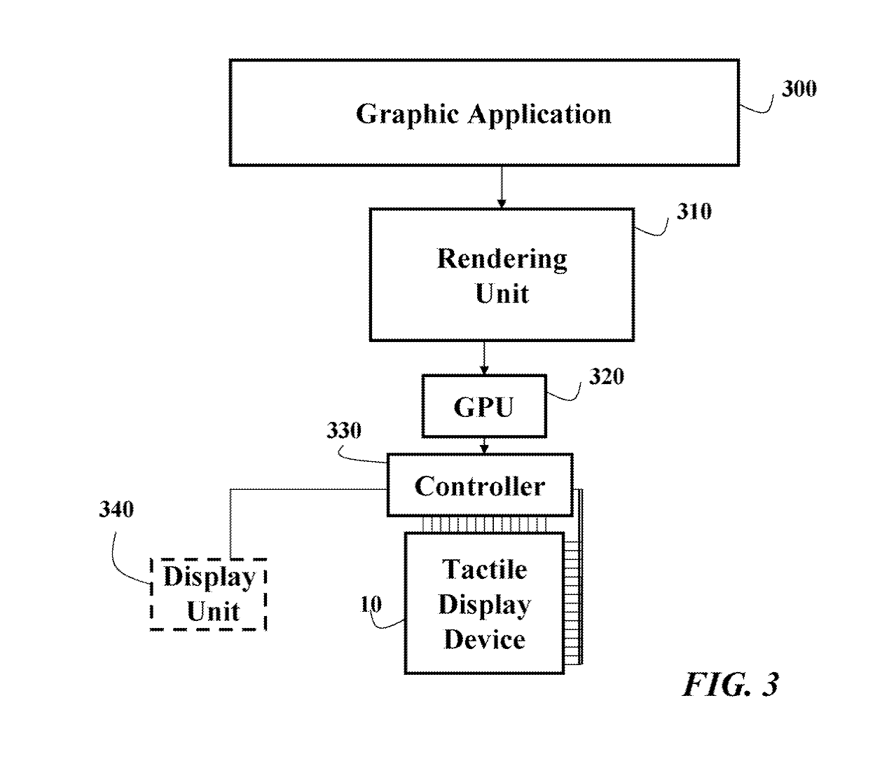

The tactile output device 10 can be incorporated into a graphic output system as shown in FIG. 3. A graphic application 300, provides output to a rendering unit 310, which in turn drives a conventional graphic processing unit (GPU) 320. Instead of being connected to a display unit, the GPU is connected to a tactile controller 330. The controller provides address decoding and current drivers for the conductors 101-102 of the tactile output device 10.

In an alternative embodiment, as shown in FIG. 3, the controller 330 can also be coupled to a frame buffer and a visual display device 340. It should be noted that the resolution of the grid points does not need to correspond exactly to the resolution of the image pixels, it can be greater of less.

It should be understood that the device 10 can be interfaced to any system that generates images, including a sequence of image (video).

The current that is supplied to the conductors, can be primary and secondary characteristics of the corresponding pixels, and combinations thereof. The characteristics can include gray-scale intensity, color, and gradients. In addition, depth values can be determined for the image, in which case the surface of the layer 100 essentially becomes a contour map of the image. The conductors can also be pulsed, depending on other image qualities or associated information known to the application. For example, the surface can be made to vibrate of pulse at different frequencies in different locations.

The device can convey three-dimensional spatial information, as well as temporal information. That is, the detectable surface features can move. In this way, the device can also be used as a navigation aid. For example, the contour is a ‘map’ of a local area in an immediate vicinity of the user, indicating perhaps, walls, doors, curbs, and other potential obstructions. The user's current location is indicated with vibration. The user can now safely navigate in a particular direction, or be guide to do so.

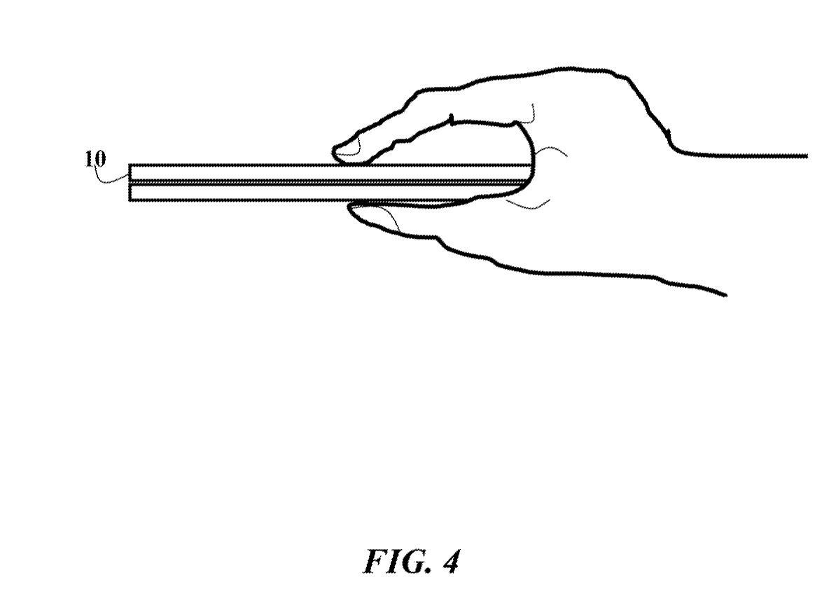

FIG. 4 shows an alternative embodiment, where two layers are used. In this embodiment the user can grasp the device like a sandwich, and receive different tactile input from each layer.

Electro-active polymers are well known, see Hamlem et al., “Electrolytically Activated Contractile Polymers,” Nature, Vol. 206, p. 1149-1150, 1965. Because of their many desirable properties, most applications, up to now, have been in the medical field, where the polymers are used to construct artificial muscle, organs, lenses, and the like. A good review is given by Brock, D L et al., “Review of Artificial Muscle Based on Contractile Polymers, ” MIT AI Memo No. 1330, November 1991. Industrial applications are also described by Shahinpoor et al., “Ionic polymer metal composites: IV. Industrial and medical application, Smart Materials and Structures, Volume 14, Issue 1, pp. 197-214, 2005.

A tunable diffraction rating is described by Aschwanden et al. “Polymeric, electrically tunable diffraction grating based on artificial muscles,” Optics Letters, Vol. 31, Issue 17, pp. 2610-2612, September 2006. A vertical membrane is made of artificial muscle, and has carbon electrodes attached to its sides. The membrane has one side molded into a diffraction grating and coated with gold to increase reflectivity. As the applied voltage varies, so does the periodicity of the diffraction grating, changing the angle of the diffracted light.

However, to the best of our knowledge, electro-active polymers have not been used in graphic application, where individual areas of the polymer are activated to convey image data as texture on a surface of the polymer.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

I claim:

1. A tactile output device, comprising:
an electro-active polymer layer;
first and second sets of conductors arranged proximate to the layer, in which the first and second sets of conductors are approximately at right angles to each other and coplanar, and the conductors in each set are spaced apart and parallel to each other to form an array of points where the conductors intersect; and
means for individually selecting the conductors to convey current to expand and contract the electro-active polymer in vicinities of the points.

2. The device of claim 1, in which the array of points correspond to a pixel array in an image.

3. The device of claim 1, in which the conductors are embedded in the layer.

4. The device of claim 1, in which the conductors are cylindrical in cross section.

5. The device of claim 1, in which the conductors are rectangular in cross section.

6. The device of claim 1, in which the conductors are deformable.

7. The device of claim 1, in which the array of points is regular.

8. The device of claim 1, in which the array of points is irregular.

9. The device of claim 1, in which an amount of expansion and contraction is controlled by an amount of the current.

10. The device of claim 1, in which the expansion and contraction forms a three-dimensional texture.

11. The device of claim 1, in which the conductors are coupled to a frame buffer.

12. The device of claim 1, in which an amount of expansion and contraction corresponds to gray-scale intensities in an image.

13. The device of claim 1, in which an amount of expansion and contraction correspond to a contour map of an image.

14. The device of claim 1, in which the conductors are pulsed at different frequencies.

15. A method for generating a three-dimensional image, comprising:
arranging first and second sets of conductors proximate to an electro-active polymer layer to form an array of points where the conductors intersect; and
selecting individually the conductors to convey current to expand and contract the electro-active polymer in vicinities of the points.

16. The method of claim 15, in which the array of points correspond to a pixel array in an image.

17. The method of claim 15, in which the expansion and contraction forms a three-dimensional texture on the layer.

18. The method of claim 15, in which the conductors are coupled to a frame buffer.

19. The method of claim 15, in which an amount of expansion and contraction corresponds to gray-scale intensities in an image.

20. The method of claim 15, in which the conductors are pulsed at different frequencies.
